(19) United States
(12) Patent Application Publication
(10) Pub. No.: US 2026/0086396 A1
(43) Pub. Date: Mar. 26, 2026

(54) HEATERS FOR A PHOTONIC PHASE SHIFTER

(71) Applicant: GlobalFoundries U.S. Inc., Malta, NY (US)

(72) Inventors: Anupam Dutta, Bangalore (IN); Riddhi Nandi, Bangalore (IN); VVSS Satyasuresh Choppalli, Bangalore (IN); Oscar Restrepo, Halfmoon, NY (US)

(21) Appl. No.: 18/895,713

(22) Filed: Sep. 25, 2024

(51) Int. Cl. G02F 1/01

(52) U.S. Cl. CPC G02F 1/0147

(57) ABSTRACT

Structures for a photonic phase shifter and methods of forming such structures. The structure comprises a device structure including a source, a drain, a body, a gate over the body, and a well laterally between the source and the drain. The structure further comprises a waveguide core including a portion that overlaps with the well. A dielectric layer is positioned between the well and the portion of the waveguide core.

### BACKGROUND

The disclosure relates to photonic chips and, more specifically, to structures for a photonic phase shifter and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used on a photonic chip to modulate the phase of light propagating in a waveguide core. One type of phase shifter may operate by a thermo-optic mechanism in which heat is transferred to the waveguide core, which is comprised of a material having a refractive index that varies with temperature.

Improved structures a photonic phase shifter and methods of forming such structures are needed.

### SUMMARY

In an embodiment, a structure comprises a device structure including a source, a drain, a body, a gate over the body, and a well laterally between the source and the drain. The structure further comprises a waveguide core including a portion that overlaps with the well. A dielectric layer is positioned between the well and the waveguide core.

In an embodiment, a structure comprises a field-effect transistor including a source, a drain, a body, and a gate over the body. The structure further comprises a waveguide core that overlaps with the gate. A dielectric layer is positioned between the gate and the waveguide core.

In an embodiment, a method comprises forming a device structure including a source, a drain, a body, a gate over the body, and a well laterally between the source and the drain. The method further comprises forming a waveguide core including a portion that overlaps with the well. A dielectric layer is positioned between the well and the waveguide core.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals are used to indicate like features in the various views.

FIG. 1 is a top view of a structure in accordance with embodiments of the invention.

FIG. 1A is a cross-sectional view taken generally along line 1A-1A in FIG. 1.

FIG. 2 is a top view of the structure at a fabrication stage subsequent to FIG. 1.

FIG. 2A is a cross-sectional view taken generally along line 2A-2A in FIG. 2.

FIG. 3 is a cross-sectional view of a structure in accordance with alternative embodiments of the invention.

FIG. 4 is a cross-sectional view of a structure in accordance with alternative embodiments of the invention.

### DETAILED DESCRIPTION

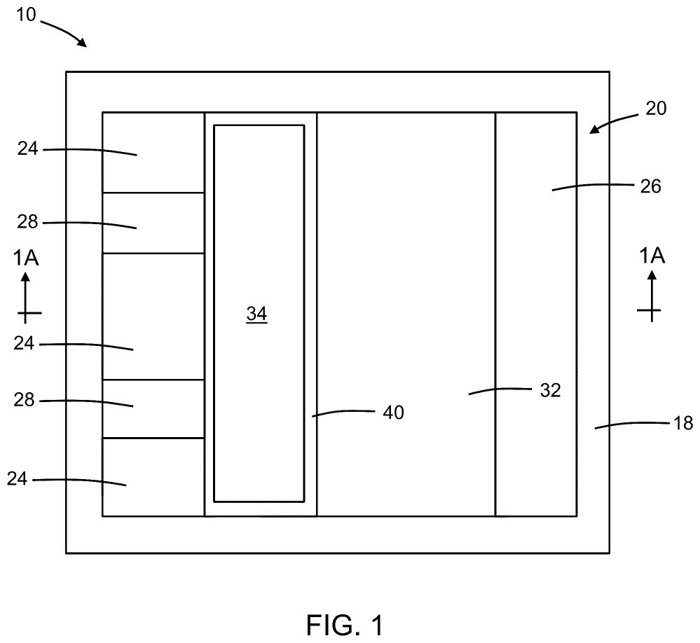

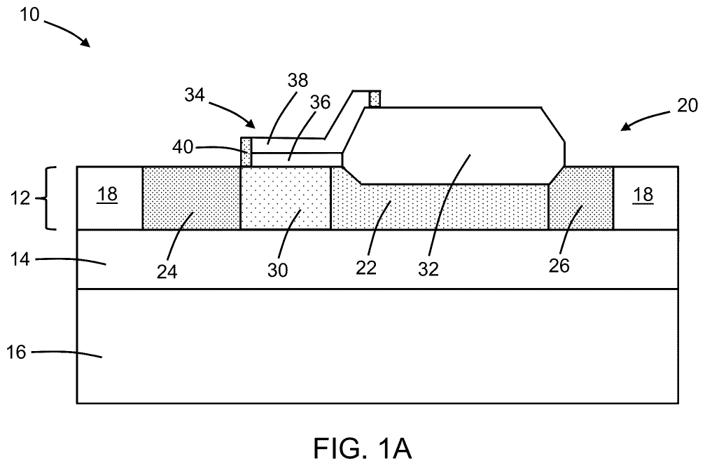

With reference to FIGS. 1, 1A and in accordance with embodiments of the invention, a structure 10 includes a semiconductor layer 12, a dielectric layer 14, and a semiconductor substrate 16. In an embodiment, the dielectric layer 14 may be comprised of a dielectric material, such as silicon dioxide, and the semiconductor substrate 16 may be comprised of a semiconductor material, such as single-crystal silicon. In an embodiment, the dielectric layer 14 may be a buried oxide layer of a silicon-on-insulator substrate, and the dielectric layer 14 may be disposed between the semiconductor layer 12 and the semiconductor substrate 16. In an embodiment, the dielectric layer 14 may have a thickness that ranges from about one (1) micrometer to about two (2) micrometers.

Shallow trench isolation regions 18 surround a device region of the semiconductor layer 12. The shallow trench isolation regions 18 may be formed by patterning shallow trenches in the semiconductor layer 12 with lithography and etching processes, depositing a dielectric material, such as silicon dioxide, in the shallow trenches, and recessing and/or planarizing the deposited dielectric material.

A device structure 20 may be formed in the device region of the semiconductor layer 12. The device structure 20 may include a well 22, doped regions 24, a doped region 26, doped regions 28, and a doped region 30 that are formed in respective portions of the semiconductor layer 12. One side portion of the well 22 adjoins the doped regions 24 and the doped regions 28 and an opposite side portion of the well 22 adjoins the doped region 26. The doped regions 24 may provide a source of the device structure 20, the doped region 26 may provide a drain of the device structure 20, the doped region 30 may provide a body of the device structure 20 that is coupled to the doped regions 28, the doped regions 28 may be coupled to the doped region 30 of the device structure 20, and the well 22 may provide a drift region or an extended drain of the device structure 20 that is arranged laterally between the body and drain. In an embodiment, the device structure 20 may be a laterally-diffused metal-oxide-semiconductor device in which the well 22 provides a drift region. In an embodiment, the device structure 20 may be an extended-drain metal-oxide-semiconductor device in which the well 22 provides an extended drain.

In an embodiment, the well 22, doped regions 24, doped region 26, doped regions 28, and doped region 30 may extend through an entire thickness of the semiconductor layer 12. In an alternative embodiment, the doped regions 24 and the doped regions 28 may extend partially through the thickness of the semiconductor layer 12. In an embodiment, the doped regions 24 and the doped regions 28 be shorted by a subsequently-formed silicide layer. In an alternative embodiment, the doped regions 24 may be separated from the doped regions 28 by trench isolation regions.

The well 22, the doped regions 24, and the doped region 26 may have a different conductivity type than the doped regions 28 and the doped region 30. In an embodiment, the well 22, the doped regions 24 and the doped region 26 may be characterized by n-type conductivity and the doped regions 28 and the doped region 30 may be characterized by p-type conductivity. In an alternative embodiment, the well 22, the doped regions 24 and the doped region 26 may be characterized by p-type conductivity and the doped regions 28 and the doped region 30 may be characterized by n-type conductivity.

In an embodiment, the well 22 may contain a concentration of an n-type dopant (e.g., arsenic or phosphorus) to provide n-type conductivity. The well 22 may be formed by selectively implanting ions, such as ions including the n-type dopant, with an implantation mask having an opening defining the intended location for the well 22 in the semiconductor layer 12. The implantation conditions (e.g., ion species, dose, kinetic energy) may be selected to tune the electrical and physical characteristics of the well 22.

In an embodiment, the doped regions 24 and the doped region 26 may contain a concentration of an n-type dopant (e.g., arsenic or phosphorus) to provide n-type conductivity. The doped regions 24 and the doped region 26 may be concurrently formed by selectively implanting ions, such as ions including the n-type dopant, with an implantation mask having openings defining the intended locations for the doped regions 24 and the doped region 26 in the semiconductor layer 12. The implantation conditions (e.g., ion species, dose, kinetic energy) may be selected to tune the electrical and physical characteristics of the doped regions 24 and the doped region 26. In an embodiment, the doped regions 24 and the doped region 26 may contain a higher dopant concentration than the well 22.

In an embodiment, the doped regions 28 and the doped region 30 may contain a concentration of a p-type dopant (e.g., boron) to provide p-type conductivity. The doped regions 28 may be formed by selectively implanting ions, such as ions including the p-type dopant, with an implantation mask having openings defining the intended locations for the doped regions 28 in the semiconductor layer 12. The doped region 30 may be formed by selectively implanting ions, such as ions including the p-type dopant, with an implantation mask having an opening defining the intended location for the doped region 30 in the semiconductor layer 12. The respective implantation conditions (e.g., ion species, dose, kinetic energy) may be selected to tune the electrical and physical characteristics of the doped regions 28 and the doped region 30. In an embodiment, the concentration of p-type dopant in the doped regions 28 may be greater than the concentration of dopant in the doped region 30.

A dielectric layer 32 may be formed in the semiconductor layer 12 that is arranged laterally between the doped region 26 and the doped region 30. In an embodiment, the dielectric layer 32 may be formed in an upper portion of the well 22 such that a lower portion of the well 22 is intact and unobstructed. In an embodiment, the dielectric layer 32 may be a field oxide that is formed by subjecting the semiconductor layer 12 to thermal oxidation in an oxidizing atmosphere (e.g., an atmosphere with an oxygen content) using a local oxidation of silicon (LOCOS) process. In an embodiment, the dielectric layer 32 may have a thickness of about 100 nanometers. In an embodiment, the thickness of the dielectric layer 14 may be greater than or equal to five times the thickness of the dielectric layer 32.

A gate 34 may be formed on, and over, the doped region 30 and a portion of the dielectric layer 32. The gate 34 may include a gate dielectric layer 36 and a gate conductor layer 38 that includes a portion that overlaps with the gate dielectric layer 36 and a portion that overlaps with a portion of the dielectric layer 32. In an embodiment, the gate dielectric layer 36 may be comprised of a dielectric material, such as silicon dioxide, and the gate conductor layer 38 may be comprised of a conductor, such as doped polysilicon. A dielectric spacer 40 comprised of a dielectric material, such as silicon nitride, may be formed that surrounds the gate 34.

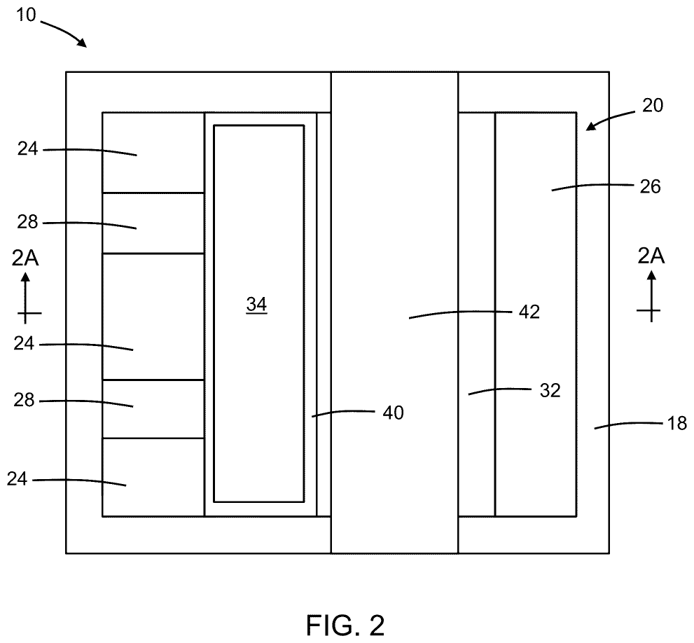

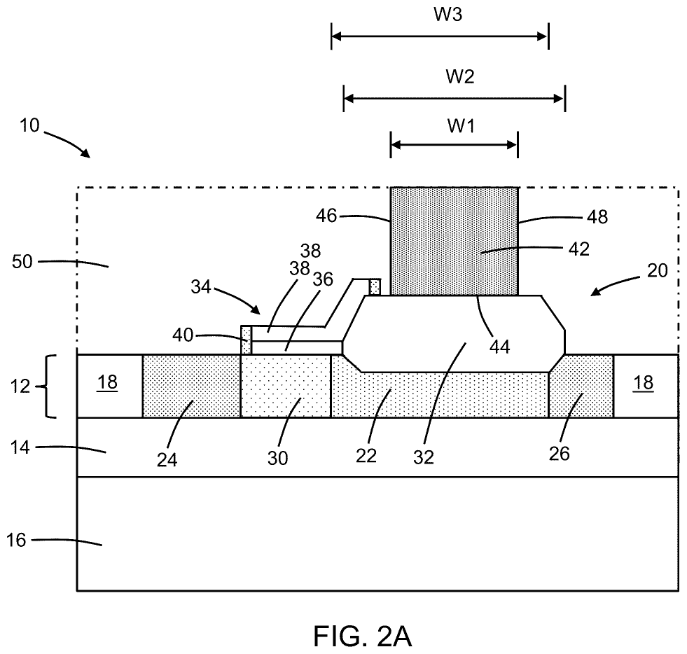

With reference to FIGS. 2, 2A in which like reference numerals refer to like features in FIGS. 1, 1A and at a subsequent fabrication stage, a waveguide core 42 is disposed on, and over, the dielectric layer 32. The waveguide core 42 includes a lower surface 44, an upper surface that is opposite from the lower surface 44, a side surface 46, and a side surface 48 that is opposite from the side surface 46. The waveguide core 42 has a width dimension W1 between the side surface 46 and the side surface 48 that is less than a width dimension W2 of the dielectric layer 32. The width dimension W1 of the waveguide core 42 is also less than a width dimension W3 of the well 22. In an embodiment, the lower surface 44 of the waveguide core 42 may be positioned in direct contact with a confronting upper surface of the dielectric layer 32. In an embodiment, the lower surface 44 of the waveguide core 42 may adjoin a confronting upper surface of the dielectric layer 32. The waveguide core 42 is separated from the well 22 by the thickness of the dielectric layer 32, which provides low-index cladding. The thickness of the dielectric layer 32 can be selected to optimize heat transfer and optical power isolation as competing factors.

A portion of the waveguide core 42 overlaps with a portion of the dielectric layer 32, and the portion of the waveguide core 42 and the portion of the dielectric layer 32 overlap with a portion of the well 22 underlying the dielectric layer 32. The waveguide core 42 is laterally positioned between the gate 34 and the doped region 26 providing the drain of the device structure 20. The waveguide core 42 is laterally offset from the gate 34 in a direction toward the doped region 26. A dielectric layer 50 comprised of a dielectric material, such as silicon dioxide, may be formed over the structure 10 after the waveguide core 42 is formed.

In an embodiment, the waveguide core 42 may be comprised of a material having a refractive index that is greater than the refractive index of silicon dioxide. In an embodiment, the waveguide core 42 may be comprised of a dielectric material, such as silicon nitride, silicon oxynitride, or aluminum nitride. In an alternative embodiment, the waveguide core 42 may be comprised of a semiconductor material, such as silicon or germanium. In alternative embodiments, other materials, such as a polymer, diamond, thin-film lithium niobate, boron nitride, barium titanate, or a III-V compound semiconductor, may be used to form the waveguide core 42. In an embodiment, the waveguide core 42 may be formed by depositing a layer comprised of its constituent material and patterning the deposited layer with lithography and etching processes.

In use, the waveguide core 42 guides propagating light past the device structure 20. Heat is generated within the well 22, during the operation of the device structure 20, by the voltage drop across the well 22. The generated heat is transferred upwardly from the well 22 through the dielectric layer 32 and to an adjacent overlying portion of the waveguide core 42. The dielectric layer 14 blocks heat transfer from the well 22 to the semiconductor substrate 16. The temperature of the adjacent portion of the waveguide core 42 is elevated by the transferred heat, which is effective to change the refractive index of the heated portion of the waveguide core 42 and thereby change the phase of the propagating light.

The device structure 20 and, in particular, the well 22 of the device structure 20 represents a heating element that can be deployed in a thermo-optic phase shifter. The power needed to achieve a given phase shift may be reduced in comparison with a conventional thermo-optic phase shifter. The thermo-optic phase shifter may occupy a smaller area and have a smaller footprint than a conventional thermo-optic phase shifter.

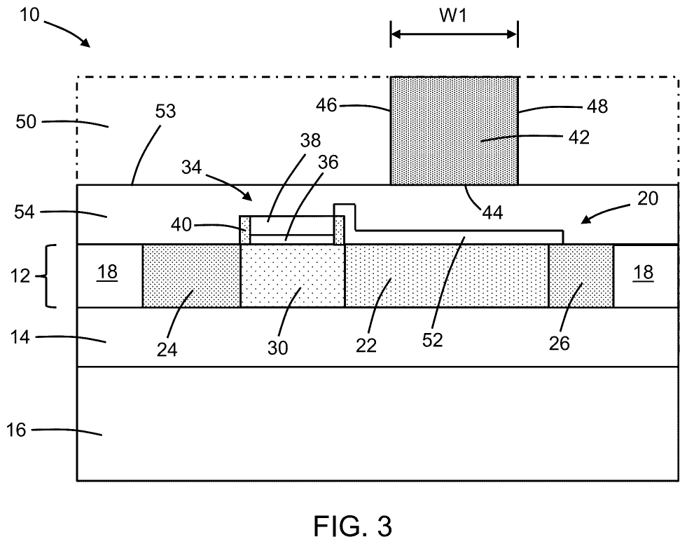

With reference to FIG. 3 and in accordance with alternative embodiments of the invention, the dielectric layer 32 may be omitted from the device structure 20, a silicide blocking layer 52 may be formed on the top surface of the semiconductor layer 12 that overlaps with the well 22, and a dielectric layer 54 may be deposited over the device structure 20 and planarized to provide a planar top surface 53. The width dimension W1 of the waveguide core 42 is less than the width dimension of the silicide blocking layer 52. The silicide blocking layer 52 prevents the formation of silicide on the semiconductor layer 12 over the well 22 when the gate conductor layer 38 of the gate 34, the doped regions 24 and doped regions 28, and the doped region 26 are silicided, which eliminates any adverse effect on light transmission in the waveguide core 42.

In an embodiment, the lower surface 44 of the waveguide core 42 may be positioned in direct contact with the confronting planar top surface 53 of the dielectric layer 54. In an embodiment, the planar top surface 53 of the dielectric layer 54 may extend laterally over the gate 34, the doped regions 24, and the doped region 26. In an embodiment, the lower surface 44 of the waveguide core 42 may adjoin a confronting surface of the dielectric layer 54. The waveguide core 42 is separated from the well 22 by the thickness of the dielectric layer 54, which provides low-index cladding. A portion of the waveguide core 42 overlaps with a portion of the dielectric layer 54, and the portion of the waveguide core 42 overlaps with a portion of the well 22 underlying the silicide blocking layer 52 and the dielectric layer 54.

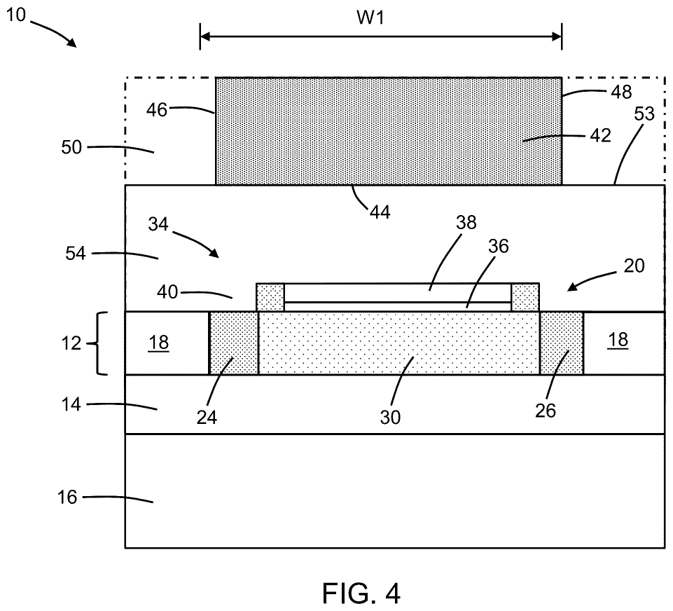

With reference to FIG. 4 and in accordance with alternative embodiments of the invention, the device structure 20 may be configured as a field-effect transistor that omits the well 22. The lower surface 44 of the waveguide core 42 may be positioned in direct contact with the confronting planar top surface 53 of the dielectric layer 54, and the waveguide core 42 may overlap with the gate 34 of the device structure 20. The device structure 20 and, in particular, the gate 34 of the device structure 20 represents a heating element that can be deployed in a thermo-optic phase shifter. The temperature of the adjacent portion of the waveguide core 42 is elevated by the heat originating from the gate 34, which is effective to change the refractive index of the heated portion of the waveguide core 42 and thereby change the phase of the propagating light.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
a device structure including a source, a drain, a body, a gate over the body, and a well between the source and the drain;
a waveguide core including a portion that overlaps with the well; and
a first dielectric layer between the well and the portion of the waveguide core.

2. The structure of claim 1 further comprising:
a silicon-on-insulator substrate including a semiconductor layer, a semiconductor substrate, and a buried oxide layer between the semiconductor layer and the semiconductor substrate,
wherein the source, the drain, the body, and the well are disposed in the semiconductor layer.

3. The structure of claim 2 wherein the first dielectric layer is positioned between the waveguide core and the well, and the well is positioned between the first dielectric layer and the buried oxide layer.

4. The structure of claim 1 further comprising:
a second dielectric layer between the first dielectric layer and the waveguide core.

5. The structure of claim 4 wherein the first dielectric layer comprises a first dielectric material, and the second dielectric layer comprises a second dielectric material different from the first dielectric material.

6. The structure of claim 1 wherein the waveguide core has a bottom surface that adjoins the first dielectric layer.

7. The structure of claim 1 wherein the waveguide core has a bottom surface in direct contact with the first dielectric layer.

8. The structure of claim 1 wherein the waveguide core has a first width dimension, and the first dielectric layer has a second width dimension that is greater than the first width dimension.

9. The structure of claim 1 wherein the waveguide core comprises a dielectric material.

10. The structure of claim 1 wherein the waveguide core comprises silicon nitride, silicon oxynitride, or aluminum nitride.

11. The structure of claim 1 wherein the waveguide core is laterally positioned between the gate and the drain.

12. The structure of claim 11 wherein the waveguide core is laterally offset from the gate.

13. The structure of claim 1 wherein the first dielectric layer has a planar top surface.

14. The structure of claim 13 wherein the waveguide core is positioned on the planar top surface of the first dielectric layer, the waveguide core is laterally offset from the gate, and the planar top surface overlaps with the gate of the device structure.

15. The structure of claim 14 further comprising:
a second dielectric layer between the first dielectric layer and the well.

16. The structure of claim 1 wherein the waveguide core is laterally offset from the gate.

17. The structure of claim 1 wherein the device structure is an extended-drain metal-oxide-semiconductor device, and the well is an extended drain of the extended-drain metal-oxide-semiconductor device.

18. The structure of claim 1 wherein the device structure is a laterally-diffused metal-oxide-semiconductor device, and the well is a drift region of the laterally-diffused metal-oxide-semiconductor device.

19. A structure comprising:
a field-effect transistor including a source, a drain, a body, and a gate over the body;
a waveguide core that overlaps with the gate; and
a dielectric layer between the gate and the waveguide core.

20. A method comprising:
forming a device structure including a source, a drain, a body, a gate over the body, and a well laterally between the source and the drain; and
forming a waveguide core including a portion that overlaps with the well,
wherein a dielectric layer is positioned between the well and the portion of the waveguide core.
